(19) United States
(12) Patent Application Publication
(10) Pub. No.: US 2018/0197094 A1
(43) Pub. Date: Jul. 12, 2018

(54) APPARATUS AND METHOD FOR PROCESSING CONTENT

(71) Applicant: Samsung Electronics Co., Ltd., Suwon-si (KR)

(72) Inventors: Hyun-woo LEE, Seoul (KR); Ji-man KIM, Suwon-si (KR); Chan-jong PARK, Seoul (KR); Do-jun YANG, Yongin-si (KR)

(21) Appl. No.: 15/863,274

(22) Filed: Jan. 5, 2018

(30) Foreign Application Priority Data
Jan. 6, 2017 (KR) 10-2017-0002553
Dec. 4, 2017 (KR) 10-2017-0165235

(51) Int. Cl. G06N 5/04; G06F 21/62; G06F 21/55

(52) U.S. Cl. CPC G06N 5/047; G06F 17/2755; G06F 21/55; G06F 21/6218

(57) ABSTRACT

A content processing apparatus and method is provided, in which content input by a user is processed by determining whether transmission of the content corresponds to an abnormal pattern when a relation between the user and the other party is taken into account, and for automatically adjusting a permissible level by learning whether the content is an abnormal pattern based on the user's response. The content processing apparatus can estimate whether the content corresponds to an abnormal pattern by using a rule-based algorithm or an artificial intelligence (AI) algorithm when determining whether the content corresponds to the abnormal pattern. When determining whether the content corresponds to the abnormal pattern is estimated using the AI algorithm, the content processing apparatus can use machine learning, a neural network algorithm, or a deep learning algorithm.

### CROSS-REFERENCE TO RELATED APPLICATION(S)

This application claims the benefit under 35 U.S.C. § 119(a) of a Korean patent application filed on Jan. 6, 2017 in the Korean Intellectual Property Office and assigned Serial number 10-2017-0002553, and of a Korean patent application filed on Dec. 4, 2017 in the Korean Intellectual Property Office and assigned Serial number 10-2017-0165235, the entire disclosure of each of which is hereby incorporated by reference.

### TECHNICAL FIELD

The present disclosure relates to apparatuses and methods for processing content. More particularly, the present disclosure relates to an artificial intelligence (AI) system for imitating the human brain's cognitive function, determination function, etc. by using a machine learning algorithm, and applications thereof.

### BACKGROUND

A serious problem may occur in personal relation when undesired content is inadvertently selected and transmitted or uploaded or when an undesired person is inadvertently selected and content is transmitted or uploaded to the undesired person during transmission or uploading of content via a messenger or a social network service (SNS).

Recently, artificial intelligence (AI) systems capable of achieving a level of human intelligence have been used in various fields. The AI systems are systems enabling machine to self-learn, self-determine, and become smarter, unlike existing rule-based smart systems. As use of the AI systems increases, a recognition rate becomes higher and thus users' preference can be more exactly understood. Accordingly, the existing rule-based smart systems have been gradually replaced with deep learning-based AI systems.

AI technology consists of machine learning (e.g., deep learning) and element techniques using machine learning.

Machine learning is algorithm technology for self-sorting/learning features of input data. The element techniques are techniques for imitating the human brain's cognitive function, determination function, etc. by using the machine learning algorithm such as deep learning, and may be classified into technical fields of, for example, linguistic comprehension, visual comprehension, inference/prediction, knowledge representation, operation control, etc.

Various fields to which the AI technology is applicable will be described below. The linguistic comprehension is a technique for identifying and applying/processing human language/characters and includes natural-language processing, machine translation, a dialogue system, questions and answers, voice recognition/synthesis, etc. The visual compression is a technique for identifying and processing an object in terms of human perspectives and includes object recognition, object tracing, video searching, recognition of human beings, scene comprehension, understanding of a space, video enhancement, etc. The inference/prediction is a technique for judging and logically reasoning information and making prediction, and includes knowledge/probability-based inference, optimizing prediction, preference-based planning, recommendation, etc. The knowledge representation is a technique for automatically processing human experience information on the basis of knowledge data, and includes knowledge construction (data creation/classification), knowledge management (data utilization), etc. The operation control is a technique for controlling self-driving of a vehicle and a robot's movement and includes motion control (navigation, crash, driving), manipulation control (behavior control), etc.

The above information is presented as background information only, to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages, and to provide at least the advantages described below. Accordingly, an aspect of the present disclosure is to provide apparatuses and methods for processing content input by a user by checking whether transmission of the content corresponds to an abnormal pattern when the other party is taken into account on the basis of existing content transmission patterns, learning whether the content corresponds to the abnormal pattern on the basis of the user's response, and automatically controlling a permissible level for determining whether the content corresponds to the abnormal pattern on the basis of a result of performing learning.

Additional aspects will be set forth in part in the description which follows and, in part, will be apparent from the description, or may be learned by practice of the presented embodiments.

In accordance with an aspect of the present disclosure, an apparatus for processing content is provided. The apparatus includes a memory to store computer executable instructions, at least one processor configured to execute the computer executable instructions that cause the at least one processor to determine whether content input by a user corresponds to an abnormal pattern based on a permissible level corresponding to another party who is to share the content, and adjust the permissible level based on the user's response to a notification regarding detection of the abnormal pattern when the content corresponds to the abnormal pattern, and an input and output unit configured to receive the content from the user, notify the user about the detection of the abnormal pattern, and receive the user's response to the notification.

In accordance with another aspect of the present disclosure, a method of processing content is provided. The method includes receiving content from a user, determining whether the content corresponds to an abnormal pattern based on a permissible level corresponding to another party who is to share the content, generating a notification to notify the user about detection of the abnormal pattern when the content corresponds to the abnormal pattern, and adjusting the permissible level based on the user's response to the notification.

In accordance with another aspect of the present disclosure, a non-transitory computer-readable recording medium having recorded thereon a program causing at least one processor of a computer to perform the method of processing content is provided.

In accordance with another aspect of the present disclosure, a computer program product storing a program causing at least one processor of a computer to perform the method of processing content is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a content processing apparatus according to an embodiment of the present disclosure;

FIG. 2 is a diagram illustrating a process of processing content, the process performed by a content processing apparatus, according to an embodiment of the present disclosure;

FIG. 3 is a diagram illustrating an example of a user interface (UI) displayed on a content processing apparatus when content corresponds to an abnormal pattern, according to an embodiment of the present disclosure;

FIG. 4 is a diagram illustrating an example of a UI displayed on a content processing apparatus when content corresponds to an abnormal pattern, according to an embodiment of the present disclosure;

FIGS. 5A, 5B, and 5C are diagrams for explaining a permissible level displayed on a content processing apparatus to determine whether content corresponds to an abnormal pattern, according to various embodiments of the present disclosure;

FIGS. 6A and 6B are diagrams for explaining application of a permissible level in a content processing apparatus at an initial learning stage and at a cumulative learning stage, according to various embodiments of the present disclosure;

FIG. 7 is a diagram for explaining control of a permissible level when a user arbitrarily transmits content corresponding to an abnormal pattern to another party via a content processing apparatus, according to an embodiment of the present disclosure;

FIG. 8 is a block diagram of a content processing apparatus according to an embodiment of the present disclosure;

FIG. 9 is a block diagram of a controller according to an embodiment of the present disclosure;

FIG. 10 is a block diagram of a data learner according to an embodiment of the present disclosure;

FIG. 11 is a block diagram of a data recognition unit according to an embodiment of the present disclosure;

FIG. 12 is a diagram illustrating an example in which data is learned and recognized by linking a content processing apparatus and a server to each other, according to an embodiment of the present disclosure;

FIG. 13 is a flowchart of a method of processing content, according to an embodiment of the present disclosure; and

FIGS. 14 and 15 are flowcharts for explaining situations in which a data recognition model is used according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used to enable a clear and consistent understanding of the present disclosure. Accordingly, it should be apparent to those skilled in the art that the following description of various embodiments of the present disclosure is provided for illustration purpose only, and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that when an element is referred to as being “connected to” another embodiment, the element can be ‘directly connected to’ the other element or can be ‘connected to the other element having another element therebetween. It will be further understood that the terms “comprises” and/or “comprising”, when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

It will be understood that, although the terms ‘first’, ‘second’, etc. may be used herein to describe various elements, these elements should not be limited by these terms. These terms are only used to distinguish one element from another element.

The term “and/or” includes any and all combinations of one or more of the associated listed items. Expressions such as “at least one of”, when preceding a list of elements, modify the entire list of elements and do not modify the individual elements of the list.

As used herein, the term “content” is a generic term for digital information provided via a wired or wireless communication network or the content of the digital information, and may be understood to include various types of information or content processed or distributed by creating characters, signs, icons, voice, photographs, video, etc. in a digital manner.

As used herein, the expression “content processing apparatus” should be understood to generally include devices capable of transmitting or uploading content input by a user to another device. Examples thereof may include not only portable devices such as smart phones or laptop computers but also fixed type devices such as desktop personal computers (PCs).

Embodiments set forth herein relate to a content processing apparatus and method, and parts thereof which are well-known to those of ordinary skill in the technical field to these embodiments pertain will not be described in detail here.

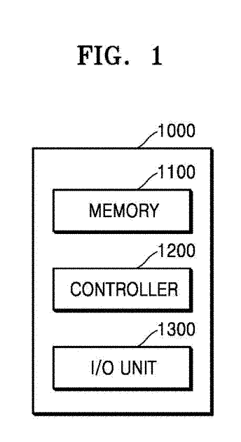

FIG. 1 is a block diagram of a content processing apparatus according to an embodiment of the present disclosure.

Referring to FIG. 1, a content processing apparatus 1000 according to an embodiment may include a memory 1100, a controller 1200, and an input/output (I/O) unit 1300.

The memory 1100 may store a program for processing and control performed by the controller 1200, and store data to be input to or output from the content processing apparatus 1000. The memory 1100 may store a computer executable instruction.

Generally, the controller 1200 controls overall operations of the content processing apparatus 1000. The controller 1200 may include at least one processor. The controller 1200 may include a plurality of processors or one integrated processor according to functions and roles thereof.

The controller 1200 may check whether content input by a user corresponds to an abnormal pattern on the basis of a permissible level corresponding to the other party who will share the content by executing the computer executable instruction stored in the memory 1100. The content processing apparatus 1000 may learn an existing content uploading history, a history of transmitting content to or receiving content from the other party, etc. and process the user's general pattern regarding content transmission as a normal pattern related to content transmission. In this case, the expression “content transmission” should be understood to mean uploading of content or transmission of content to the other party. That the content corresponds to the abnormal pattern should be understood to mean that a part or all of the content does not match a normal pattern.

At least one processor of the controller 1200 may analyze content input by the user, obtain at least one feature to be used to identify the user's pattern regarding content transmission, and detect an abnormal pattern on the basis of the obtained feature and a permissible level. The permissible level may vary according to the other party who will share the content input by the user. In this case, the other party should be understood to include a single party, a plurality of parties, a specific person, or unspecified persons. A permissible level for even the same content may vary according to the other party who will share the content. Accordingly, even if content transmitted as a normal pattern to the other party A may be treated as an abnormal pattern when the content is transmitted to the other party B.

When there is no information regarding a permissible level corresponding to the other party, at least one processor of the controller 1200 may check whether content corresponds to an abnormal pattern on the basis of a permissible level corresponding to a relation type to which the other party belongs. For example, a common permissible level corresponding to each relation type may be predetermined according to whether the other party is a colleague at work, a family member, a friend, or the like. In particular, when no content has ever been transmitted to or received from the other party, no permissible level corresponds to the other party. Accordingly, a common permissible level corresponding to a relation type to which the other party belongs may be set to be an initial value of a permissible level corresponding to the other party.

If the content corresponds to an abnormal pattern, at least one processor of the controller 1200 may stop transmission of content regardless of whether a command to transmit the content is received from the user. The controller 1200 may control the I/O unit 1300 to provide a notification regarding detection of the abnormal pattern, together with a manipulation interface permitting cancellation of the transmission of the content.

When the content corresponds to the abnormal pattern, the controller 1200 may adjust the permissible level on the basis of the user's response to the notification regarding the detection of the abnormal pattern.

When the user transmits content from which an abnormal pattern is detected to the other party, at least one processor of the controller 1200 may adjust the permissible level such that similar content corresponding to the detected abnormal pattern may be treated as a normal pattern. When the user transmits content determined by the controller 1200 as corresponding to an abnormal pattern while ignoring the determination, the content cannot be considered as corresponding to the abnormal pattern and may be thus treated and learned as corresponding to a normal pattern. The permissible level may be controlled accordingly.

At least one processor of the controller 1200 may gradually adjust the permissible level by cumulatively learning normal patterns of content related to the other party according to the user's response.

When the permissible level includes sub-permissible levels corresponding to types of abnormal patterns, at least one processor of the controller 1200 may control a sub-permissible level corresponding to a type of an abnormal level detected from content on the basis of the user's response.

At least one processor of the controller 1200 may control only the permissible level corresponding to the other party according to the user's response.

When content does not correspond to an abnormal pattern, at least one processor of the controller 1200 may adjust the permissible level on the basis of the other party's response or a user's response after transmission of the content.

The permissible level may be changed according to a change in information representing a level of intimacy between the other party and a user. For example, the permissible level may be increased with respect to the other party having a higher level of intimacy with the user among other parties belonging to the same relation type so that content to be transmitted to the other party may be treated as a normal pattern, and may be decreased with respect to the other party having a lower level of intimacy with the user among the other parties so that the content may be treated as an abnormal pattern.

The I/O unit 1300 may receive content from a user. The I/O unit 1300 may notify the user of detection of an abnormal pattern and receive the user's response to the notification.

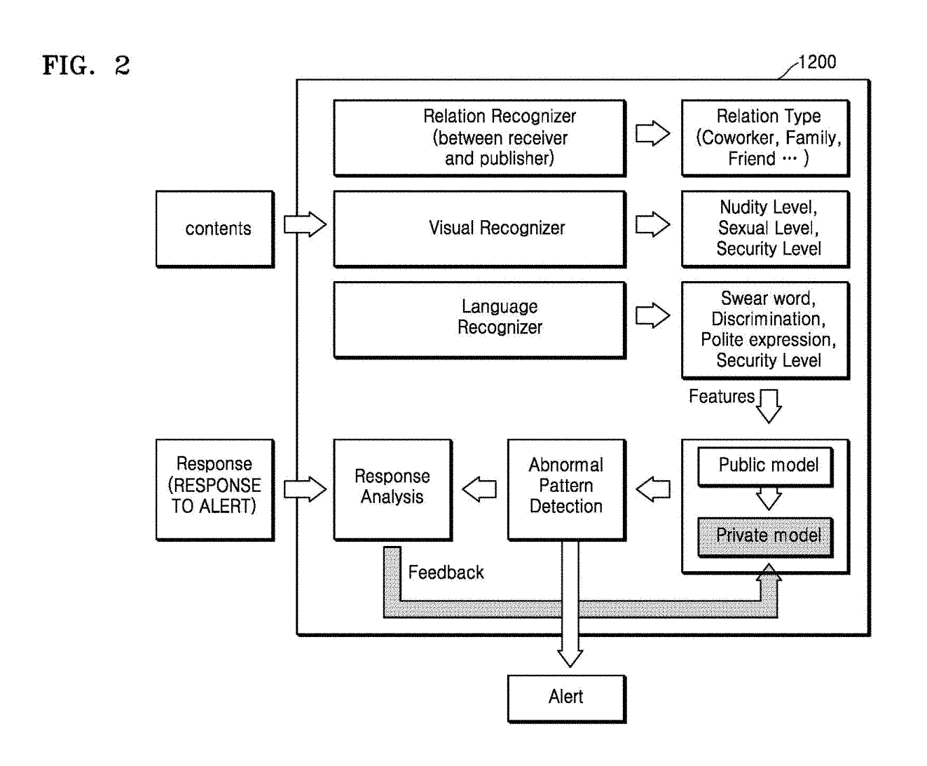

FIG. 2 is a diagram illustrating a process of processing content, the process performed by a content processing apparatus of FIG. 1, according to an embodiment of the present disclosure.

Referring to FIG. 2, content input by a user is transmitted to the controller 1200 of the content processing apparatus 1000. The controller 1200 may analyze the content by using at least one processor thereof. For example, the controller 1200 may obtain a relation type indicating a relation between a person who will transmit the input content and a person who will receive the input content, obtain a certain image from visual materials contained in the content, or obtain a certain expression from language included in the content. That is, the controller 1200 may analyze the content and obtain at least one feature to be used to identify a general pattern regarding transmission of the content by using at least one processor thereof.

For example, the relation type indicating a relation between the other party who will share content and a user may be a colleague at work, a family member, a friend, a lover, unspecified persons, or the like. A way of speaking or a level of dialogue may vary according to the other party and whether the content will be disclosed may depend on the other party. Accordingly, the relation type may be an important parameter for checking whether content which is to be transmitted corresponds to an abnormal pattern.

When content is input to the controller 1200, the controller 1200 may identify a type of relation between the user and the other party who will share the content by using a relation recognizer. The relation recognizer may be embodied as one processor or a module included in a processor. For example, when information regarding the type of relation between the other party and the user may be obtained from an application executable by the content processing apparatus 1000 or when information regarding the type of relation has already been stored, the relation recognizer may access a place storing the information regarding the type of relation by calling an application programming interface (API) provided from either the content processing apparatus 1000 or an outside connected via a network, and obtain the information regarding the type of relation between the other party and the user.

When the information regarding the type of relation between the other party and the user cannot be obtained, the relation recognizer may estimate the type of relation between the other party and the user from language such as characters or text input by the user or the other party or content exchanged between the user and the other party. For example, the relation recognizer may identify, by using a language recognition model, content of a current conversation, a way of speaking, a level of a swear word, a length of a sentence, whether a polite expression is used or not, etc. As another example, the relation recognizer may identify the content, rank, or level of a video by classifying features of exchanged content according to a certain criterion by using a video recognition model. The relation recognizer may estimate the type of relation between the other party and the user by considering the identified matters overall.

When content includes visual materials such as a photograph, a video, etc., whether there is a feature such as a nudity level or a level of expression of a video may be checked and then a security level may be checked.

When content is input to the controller 1200, the controller 1200 may identify a nudity level, a sexual level, a security level, etc. with respect to the input content by using a visual recognizer. The visual recognizer may be embodied as one processor or a module included in a processor.

The visual recognizer may obtain a feature of a photograph, a video, or the like input by a user by using a video recognition model, classify the obtained feature according to a certain criterion, and identify a nudity level, a sexual level, a security level, etc. For example, the nudity level may be identified to be high when in a photograph including a person, there is much flesh color in a region including the person and the person hardly wears clothes. When the content input by the user is a moving picture, the visual recognizer may capture a feature changing with time from frames of the moving picture or capture a region commonly included in the frames, and analyze the feature by applying the captured feature or the captured region to the video recognition model. For example, a level of violence may be determined to be high when in a moving picture including a person, the person's behavior is considered as using violence or committing murder and such a behavior is frequently repeated or occupies a large percentage of the moving picture.

When content includes language such as characters or text, whether there is a feature such as various types of discrimination, e.g., a swear word, racial discrimination, sexual discrimination, etc., and impolite expressions may be checked, and then a security level may be checked.

When content is input to the controller 1200, the controller 1200 may identify a swear word, racial discrimination, sexual discrimination, a security level, etc. of the input content by using a language recognizer. The language recognizer may be embodied as one processor or a module included in a processor. The language recognizer may analyze morphemes of language, such as characters or text, which is input by a user by using the language recognition model, and identify the morphemes and a sentence so as to identify a swear word, racial discrimination, sexual discrimination, a security level, etc.

The controller 1200 checks whether transmission of content to the other party who will share the content corresponds to an abnormal pattern or not on the basis of a feature obtained by analyzing the content and a permissible level. The controller 1200 may check whether a nudity level, a sexual level, and a security level identified from content input by the user are appropriate or check whether levels of a swear word, racial discrimination, sexual discrimination, etc. identified from the content input by the user are appropriate on the basis of a permissible level according to a type of relation between the user and the other party who will share the content with the user. In this case, when there is no information regarding a permissible level corresponding to the other party, whether the content corresponds to an abnormal pattern may be determined by referring to a public model and on the basis of a permissible level corresponding to a relation type to which the other party belongs. When there is information regarding a permissible level corresponding to the other party, whether the content corresponds to an abnormal pattern may be determined according to a private model fitted to the relation between the user and the other party.

When the content corresponds to an abnormal pattern, the controller 1200 may control the content processing apparatus 1000 to notify the user of detection of the abnormal pattern. The controller 1200 may receive the user's response to the notification regarding the detection of the abnormal pattern, analyze the user's response, and provide a feedback to adjust the permissible level corresponding to the other party. In this case, when there is no information regarding a permissible level corresponding to the other party and thus a permissible level corresponding to the relation type to which the other party belongs is used by referring to the public model, a permissible level corresponding to the other party may be created as a private model by reflecting the feedback. When the permissible level corresponding to the other party is used according to the private model fitted to the relation between the user and the other party, the private model may be learned by reflecting the feedback and thus the private model may be refined.

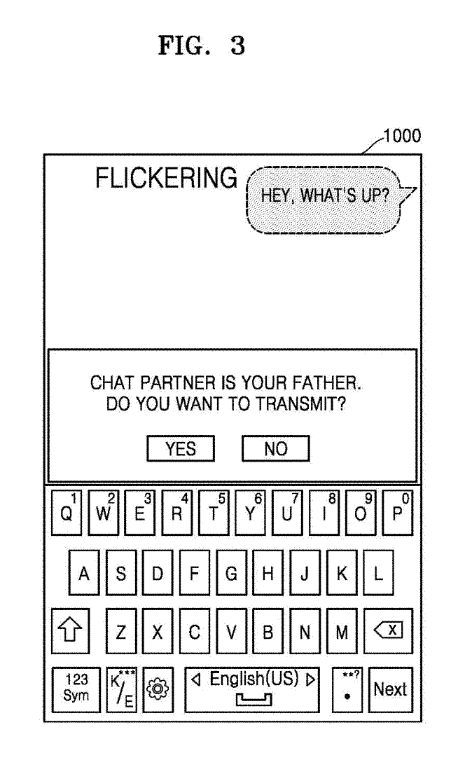

FIG. 3 is a diagram illustrating an example of a user interface (UI) displayed on a content processing apparatus of FIG. 1 when content corresponds to an abnormal pattern, according to an embodiment of the present disclosure.

Referring to FIG. 3, a case is illustrated in which a user inputs text type content “Hey, what's up?” to a chat window by executing a messenger application in the content processing apparatus 1000, but where the other party is not the user's friend and instead, is the user's father.

The content processing apparatus 1000 checks whether the content input by the user corresponds to an abnormal pattern on the basis of a permissible level corresponding to ‘father’. Although the text type content “Hey, what's up?” does not include an impolite expression, this content does not include a polite expression and is considered as corresponding to an abnormal pattern on the basis of the permissible level corresponding to ‘father’. That is, the text type content “Hey, what's up?” which is input by the user does not correspond to normal-pattern content which may be used between the user and the user's father.

Since the abnormal-pattern content is detected, the content processing apparatus 1000 may stop transmission of the content not to transmit the content to the user's father, and notify the user of the detection of the abnormal pattern. For example, as illustrated in FIG. 3, in order to notify the detection of the abnormal pattern, the content input by the user may be displayed to flicker on a screen of the content processing apparatus 1000 and the notification regarding the detection of the abnormal pattern may be provided together with a manipulation interface permitting cancellation of the transmission of the content.

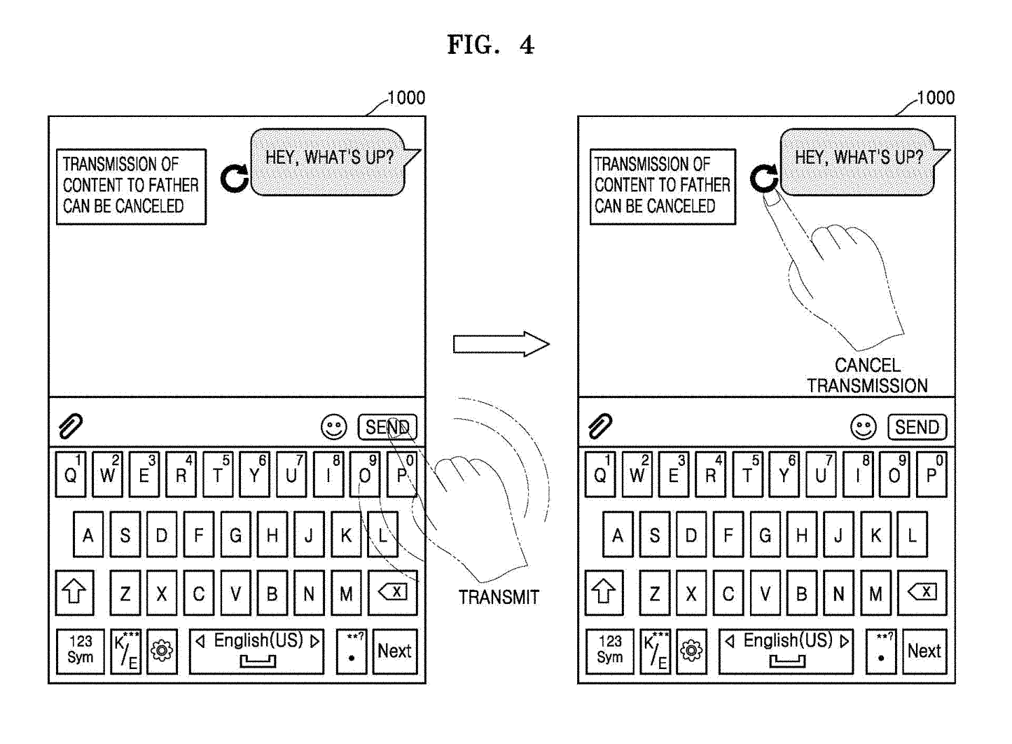

FIG. 4 is a diagram illustrating an example of a UI displayed on a content processing apparatus of FIG. 1 when content corresponds to an abnormal pattern, according to an embodiment of the present disclosure.

Referring to FIG. 4, a case is illustrated in which a user inputs text type content “Hey, what's up?” to a chat window by executing a messenger application in the content processing apparatus 1000, but where the other party is not the user's friend and instead, is the user's father.

The content processing apparatus 1000 checks whether the content input by the user corresponds to an abnormal pattern on the basis of a permissible level corresponding to ‘father’. Although the text type content “Hey, what's up?” does not an impolite expression, this content does not include a polite expression and is considered as corresponding to an abnormal pattern on the basis of the permissible level corresponding to ‘father’. That is, the text type content “Hey, what's up?” which is input by the user does not correspond to normal-pattern content which may be used between the user and the user's father.

Since the abnormal-pattern content is detected, the content processing apparatus 1000 may notify the user of the detection of the abnormal pattern in the form of vibration, in response to the user's command to transmit the content, and stop or delay transmission of the content not to transmit the content to the user's father. For example, as illustrated in FIG. 4, in order to notify the detection of the abnormal pattern, the notification regarding the detection of the abnormal pattern may be transmitted to the user in the form of vibration, together with a manipulation interface permitting cancellation of the transmission of the content. If the content processing apparatus 1000 is set to delay content transmission for a predetermined time period when an abnormal pattern is detected, the content may be transmitted to the other party after the predetermined time period and thus the user may cancel the transmission of the content by using a transmission cancellation manipulation interface.

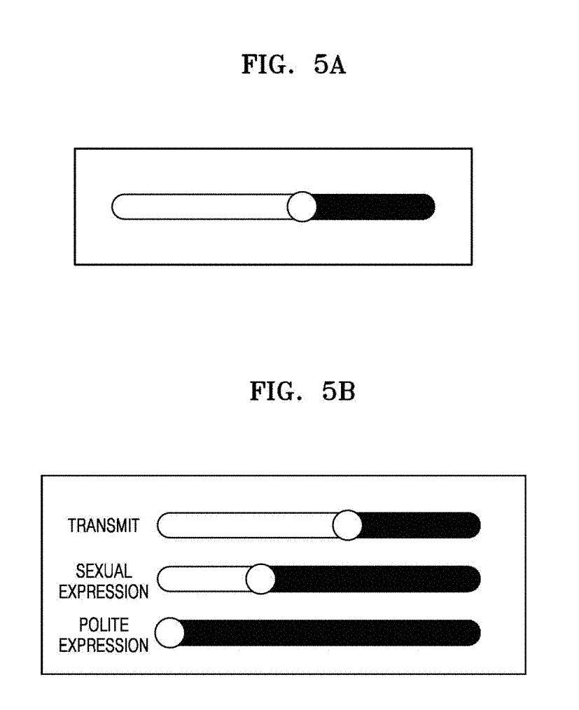

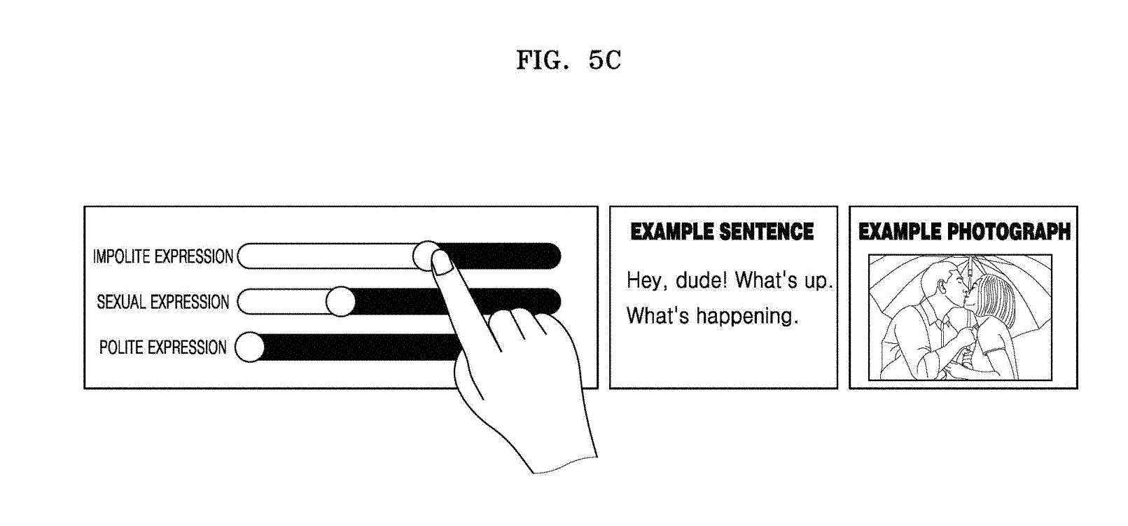

FIGS. 5A, 5B, and 5C are diagrams for explaining a permissible level displayed on a content processing apparatus of FIG. 1 to check whether content corresponds to an abnormal pattern, according to various embodiments of the present disclosure.

Referring to FIG. 5A, a permissible level for determining whether content corresponds to an abnormal pattern is controlled using one control tool. The permissible level may be differently provided for the other party and thus the content processing apparatus 1000 may independently control only a permissible level corresponding to a specific the other party.

Referring to FIG. 5B, a permissible level for determining whether content corresponds to an abnormal pattern includes sub-permissible levels for sub-types which may be used as criteria for checking an abnormal pattern, and may be independently controlled in units of the sub-permissible levels. For example, when the content processing apparatus 1000 is learned to treat even content including certain levels of swear words as a normal pattern according to a relation between a user and the other party, a sub-permissible level corresponding to impolite expressions may be controlled to be higher. The content processing apparatus 1000 may control a sub-permissible level corresponding to the type of an abnormal pattern detected from content on the basis of the user's response.

Referring to FIG. 5C, an example is provided in which a user changes a permissible level which may be used as a criterion for checking whether content corresponds to an abnormal pattern and thus, an example sentence or photograph corresponding to the permissible level is provided to the user. When the user directly changes the permissible level, the example sentence or photograph is provided to the user so that the user may view the changed permissible level. For example, the user may change the permissible level to a certain level and obtain training data corresponding to the changed level for learning a data recognition model for determining whether content corresponds to an abnormal pattern. Training data corresponding to each of permissible levels may be previously provided in a server outside the content processing apparatus 1000. As illustrated in FIG. 5C, when the permissible level for determining whether content corresponds to an abnormal pattern includes sub-permissible levels corresponding to sub-types which may be used as criteria to determine an abnormal pattern, the user may make the data recognition model to be learned by individually changing the sub-permissible levels and obtaining training data corresponding to the changed sub-permissible levels.

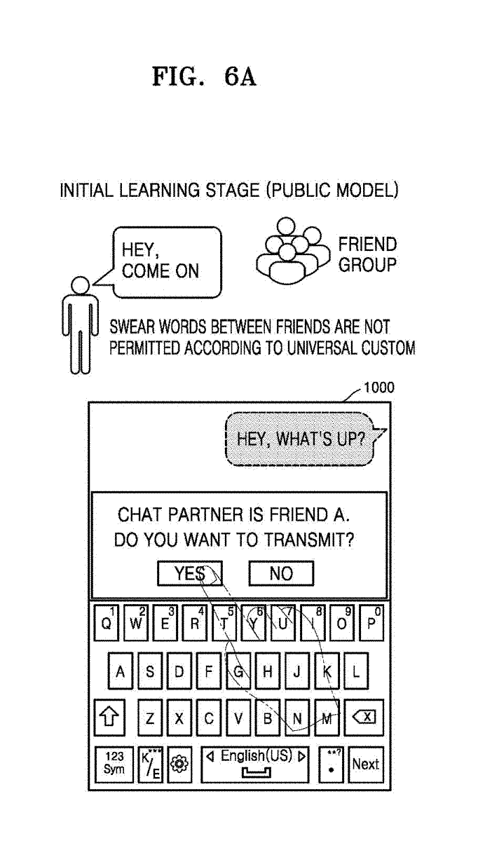

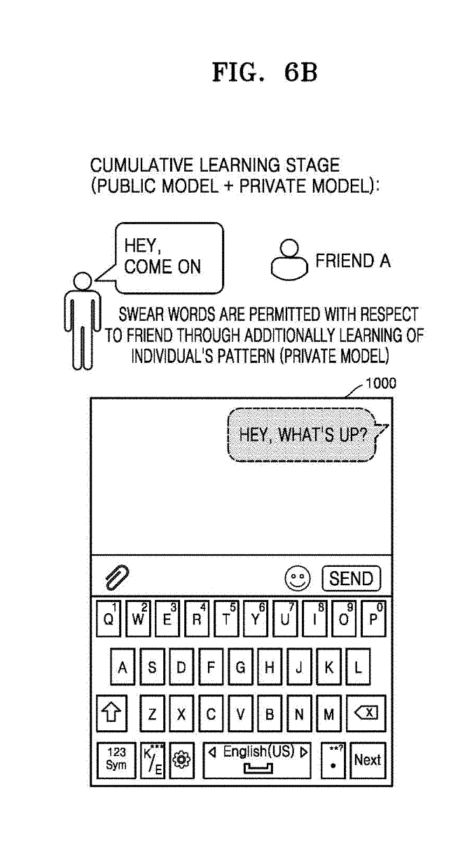

FIGS. 6A and 6B are diagrams for explaining application of a permissible level in a content processing apparatus of FIG. 1 at an initial learning stage and at a cumulative learning stage, according to various embodiments of the present disclosure.

At the initial learning stage, in the content processing apparatus 1000, a permissible level is provided such that a public model is applied to each of other parties according to a relation type to which each of the other parties belongs rather than a private model. That is, when there is no information regarding a permissible level corresponding to the other party, the content processing apparatus 1000 may check whether content corresponds to an abnormal pattern on the basis of a permissible level corresponding to the relation type to which the other party belongs.

Referring to FIG. 6A, a case is provided in which the other party is a ‘friend A’ and a user inputs text type content “Hey, what's up?” into a chat window by executing a messenger application in the content processing apparatus 1000. At the initial learning stage, there is no information regarding a permissible level corresponding to ‘friend A’ and thus when a relation type is friend, whether the content corresponds to an abnormal pattern may be determined on the basis of a permissible level corresponding to the relation type. As a result, since swear words are not permitted according to a universal custom between friends, the text type content “Hey, what's up?” is determined to correspond to an abnormal pattern and thus a popup window indicating detection of the abnormal pattern is generated in the content processing apparatus 1000. In this case, the popup window may include either a message indicating the abnormal pattern or a confirmation message inquiring of the user about whether content detected as an abnormal pattern is to be transmitted to the other party as the content is input by the user. For example, as illustrated in FIG. 6A, when the user views information regarding the other party displayed on the popup window and the confirmation message inquiring about whether the content is to be transmitted and inputs a request to transmit the content detected as an abnormal pattern so as to proceed with the transmission of the content detected as the abnormal pattern, the permissible level corresponding to ‘friend A’ may be adjusted on the basis of the user's response disregarding the detected abnormal pattern.

Referring to FIG. 6B, although the other party is ‘friend A’ and a user inputs text type content “Hey, what's up?” into a chat window by executing a messenger application in the content processing apparatus 1000, the popup window, as shown in FIG. 6A, indicating detection of an abnormal pattern is not generated. This is because at a cumulative learning stage, permitting use of sear words with respect to the friend A has been learned and thus a permissible level corresponding to ‘friend A’ has been adjusted.

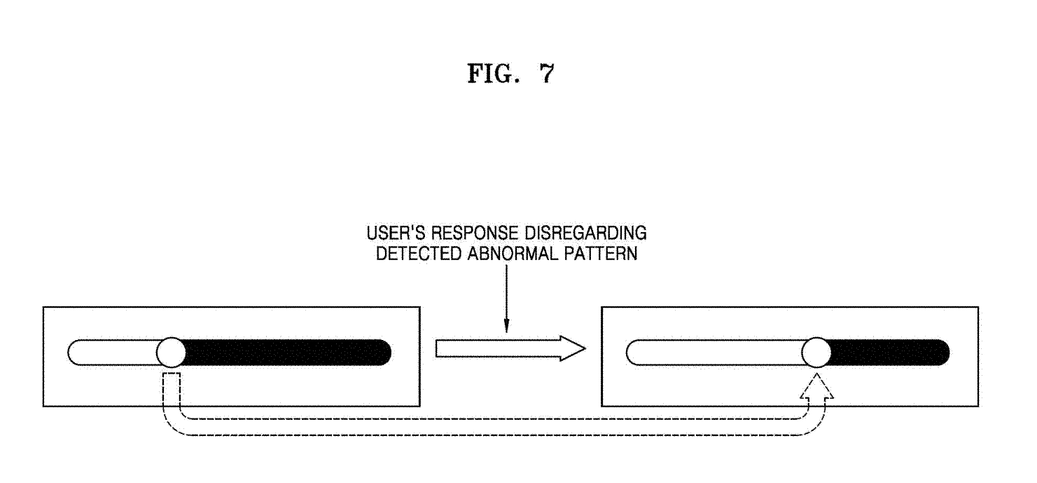

FIG. 7 is a diagram for explaining control of a permissible level when a user arbitrarily transmits content corresponding to an abnormal pattern to another party via a content processing apparatus of FIG. 1, according to an embodiment of the present disclosure.

Referring to FIG. 7, although content is determined to correspond to an abnormal pattern, the user proceeds with transmission of the content, the user's response may be learned and a permissible level may be automatically adjusted such that similar content corresponding to the abnormal pattern will be treated as a normal pattern. When in the content processing apparatus 1000, the user disregards that content detected as corresponding to an abnormal pattern and transmits the content to the other party, the permissible level may be automatically adjusted to be higher as illustrated in FIG. 7 so that content which will be detected as an abnormal pattern may be determined to correspond to a normal pattern with respect to the same other party.

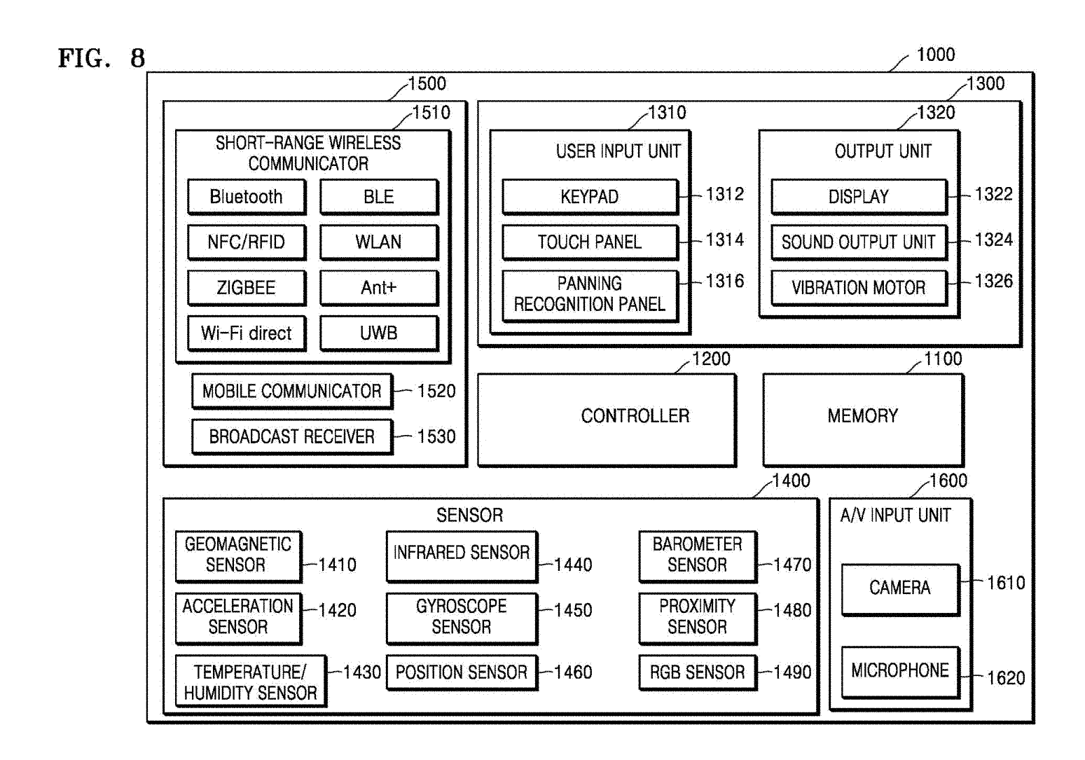

FIG. 8 is a block diagram of a content processing apparatus of FIG. 1 according to an embodiment of the present disclosure.

Referring to FIG. 8, the content processing apparatus 1000 according to an embodiment may include the memory 1100, the controller 1200, the I/O unit 1300, a sensor 1400, a communicator 1500, and an audio/video (A/V) input unit 1600.

The memory 1100 may store a program for processing and controlling performed by the controller 1200, and store data to be input to or output from the content processing apparatus 1000. The memory 1100 may store a computer executable instruction.

The memory 1100 may include at least one type storage medium among a flash memory type storage medium, a hard disk type storage medium, a multimedia card micro type storage medium, a card type memory (e.g., a secure digital (SD) or extreme digital (XD) memory or the like), a random access memory (RAM), a static RAM (SRAM), a read-only memory (ROM), an electrically erasable programmable ROM (EEPROM), a programmable ROM (PROM), a magnetic memory, a magnetic disk, and an optical disc.

Programs stored in the memory 1100 may be classified into a plurality of modules according to functions thereof. For example, the programs may be classified into a UI module, a touch screen module, a notification module, etc.

The UI module may provide a specialized UI, a specialized graphical UI (GUI), etc. linked to the content processing apparatus 1000 in units of applications. The touch screen module may sense a touch gesture on a user's touch screen and provide the controller 1200 with information regarding the touch gesture. In some embodiments, the touch screen module may recognize and analyze touch code. The touch screen module may be embodied as a separate hardware component. Examples of the user's touch gesture may include tapping, touching & holding, double tapping, dragging, panning, flicking, dragging & dropping, swiping, etc. The notification module may generate a signal indicating generation of an event in the content processing apparatus 1000. Examples of the event generated in the content processing apparatus 1000 may include reception of a message, a key signal input, a content input, content transmission, detection of content matching a certain condition, etc. The notification module may output a notification signal in the form of a video signal via a display 1322, output the notification signal in the form of an audio signal via a sound output unit 1324, or output the notification signal in the form of a vibration signal via a vibration motor 1326.

Generally, the controller 1200 controls overall operations of the content processing apparatus 1000. For example, the controller 1200 may generally control the I/O unit 1300, the sensor 1400, the communicator 1500, the A/V input unit 1600, etc. by executing the programs stored in the memory 1100.

In detail, the controller 1200 may include at least one processor. The controller 1200 may include a plurality of processors or one integrated processor according to functions and roles thereof.

The controller 1200 may execute the computer executable instruction stored in the memory 1100 to check whether content corresponds to an abnormal pattern on the basis of a permissible level corresponding to the other party who will share content input by the user.

At least one processor of the controller 1200 may obtain at least one feature to be used to identify the user's pattern by analyzing content input by the user, and detect an abnormal pattern on the basis of the obtained feature and the permissible level.

When there is no information regarding a permissible level corresponding to the other party, at least one processor of the controller 1200 may check whether content corresponds to an abnormal pattern on the basis of a permissible level corresponding to a relation type to which the other party belongs.

When content corresponds to an abnormal pattern, at least one processor of the controller 1200 may stop transmission of the content regardless of the user's command to transmit the content. The controller 1200 may control the I/O unit 1300 to provide notification regarding detection of the abnormal pattern together with a manipulation interface permitting cancellation of the transmission of the content.

When content corresponds to an abnormal pattern, the controller 1200 may control a permissible level on the basis of the user's response to the notification regarding detection of the abnormal pattern.

When the user transmits content from which an abnormal pattern is detected to the other party who will share the content, at least one processor of the controller 1200 may adjust the permissible level such that similar content corresponding to the detected abnormal pattern may be treated as a normal pattern.

At least one processor of the controller 1200 may gradually adjust the permissible level by cumulatively learning normal patterns of content related to the other party according to the user's response.

When the permissible level includes sub-permissible levels corresponding to types of abnormal patterns, at least one processor of the controller 1200 may adjust a sub-permissible level corresponding to a type of an abnormal level detected from content on the basis of the user's response.

At least one processor of the controller 1200 may independently adjust only the permissible level corresponding to the other party on the basis of the user's response.

When content does not correspond to an abnormal pattern, at least one processor of the controller 1200 may adjust the permissible level on the basis of the other party's response or a user's response after transmission of the content.

The permissible level may be changed according to a change in information representing a level of intimacy between the other party and the user.

The I/O unit 1300 may include a user input unit 1310 and an output unit 1320. In the I/O unit 1300, the user input unit 1310 and the output unit 1320 may be separated from each other or may be integrated into one form as in a touch screen.

The I/O unit 1300 may receive content from the user. The I/O unit 1300 may notify the user about detection of an abnormal pattern and receive the user's response to the notification.

The user input unit 1310 may include any suitable feature through which the user inputs data for controlling the content processing apparatus 1000. Examples of the user input unit 1310 may include, but are not limited to, a key pad 1312, a touch panel 1314 (a touch-type capacitive touch panel, a pressure-type resistive overlay touch panel, an infrared sensor-type touch panel, a surface acoustic wave conduction touch panel, an integration-type tension measurement touch panel, a piezo effect-type touch panel, etc.), and a panning recognition panel 1316. Furthermore, the user input unit 1310 may be a jog wheel, a jog switch, or the like, but is not limited thereto.

The output unit 1320 may output an audio signal, a video signal, or a vibration signal. The output unit 1320 may include the display 1322, the sound output unit 1324, and the vibration motor 1326.

The display 1322 outputs and displays information processed by the content processing apparatus 1000. For example, the display 1322 may display a messenger or SNS application execution screen to transmit or upload content, or may display a UI through which the user's manipulation is input.

When the display 1322 and a touch pad form to make a touch screen, the display 1322 may be used not only an output device but also an input device. The display 1322 may include at least one among a liquid crystal display a thin film transistor-liquid crystal display, an organic light-emitting diode, a flexible display, a three-dimensional (3D) display, and an electrophoretic display. The content processing apparatus 1000 may include two or more displays 1322 according to a type of the content processing apparatus 1000. In this case, the two or more displays 1322 may be arranged using a hinge to face each other.

The sound output unit 1324 outputs audio data which is received from the communicator 1500 or stored in the memory 1100. Furthermore, the sound output unit 1324 outputs an audio signal (e.g., call signal reception sound, message reception sound, or notification sound) related to a function performed by the content processing apparatus 1000. The sound output unit 1324 may include a speaker, a buzzer, or the like.

The vibration motor 1326 may output a vibration signal. For example, the vibration motor 1326 may output a vibration signal corresponding to an output of audio data or video data (e.g., call signal reception sound, message reception sound). Furthermore, the vibration motor 1326 may output a vibration signal when a touch is input to a touch screen.

The sensor 1400 may sense a state of the content processing apparatus 1000 or a state of the surroundings of the content processing apparatus 1000, and transmit information regarding the sensed state to the controller 1200.

The sensor 1400 may include, but is not limited thereto, at least one among a geomagnetic sensor 1410, an acceleration sensor 1420, a temperature/humidity sensor 1430, an infrared sensor 1440, a gyroscope sensor 1450, a position sensor (e.g., a global positioning system (GPS)) 1460, a barometer sensor 1470, a proximity sensor 1480, and a red, green, blue (RGB) sensor (an illuminance sensor) 1490. Since functions of these sensors would be intuitively inferred from the names of the sensors by those of ordinary skill in the art and are thus not described in detail here.

The communicator 1500 may include one or more components to establish communication between the content processing apparatus 1000 and another device or between servers. For example, the communicator 1500 may include a short-range wireless communicator 1510, a mobile communicator 1520, and a broadcast receiver 1530.

Examples of the short-range wireless communicator 1510 may include, but are not limited to, a Bluetooth communicator, a Bluetooth low energy (BLE) communicator, a near-field communicator, a wireless local access network (WLAN) (Wi-Fi) communicator, a ZigBee communicator, an infrared data association (IrDA) communicator, a Wi-Fi direct (WFD) communicator, a ultra-wideband (UWB) communicator, an Ant+ communicator, etc.

The mobile communicator 1520 transmits a radio signal to or receives a radio signal from at least one among a base station, an external terminal, and a server in a mobile communication network. Here, the radio signal may be understood to include a voice call signal, a video call signal, or various types of data generated when text/multimedia messages are transmitted and received.

The broadcast receiver 1530 receives a broadcast signal and/or broadcast-related information from the outside via a broadcast channel. The broadcast channel may include a satellite channel, a terrestrial channel, or the like. In an embodiment, the content processing apparatus 1000 may not include the broadcast receiver 1530.

The communicator 1500 may communicate with another device, a server, a peripheral device, or the like to transmit, receive, or upload content.

The A/V input unit 1600 is configured to input an audio signal or a video signal and may include a camera 1610, a microphone 1620, etc. The camera 1610 may obtain a video frame, such as a still image or a moving picture, through an image sensor in a video call mode or a shooting mode. An image captured via the image sensor may be processed by the controller 1200 or an additional image processor (not shown).

A video frame processed by the camera 1610 may be stored in the memory 1100 or may be transmitted to the outside via the communicator 1500. Two or more cameras 1610 may be provided according to an embodiment of according to a type of the content processing apparatus 1000.

The microphone 1620 receives an external audio signal and converts the received audio signal into electrical voice data. For example, the microphone 1620 may receive an audio signal from an external device or a speaker. The microphone 1620 may use various types of noise rejection algorithms to remove noise generated when an external audio signal is received.

The structure of the content processing apparatus 1000 illustrated in FIG. 8 is merely an example. The components of the content processing apparatus 1000 may be combined or omitted or new components may be added thereto according to the specifications of the content processing apparatus 1000 which are implemented. That is, two or more components may be combined into one component or one component may be subdivided into two or more components, if necessary.

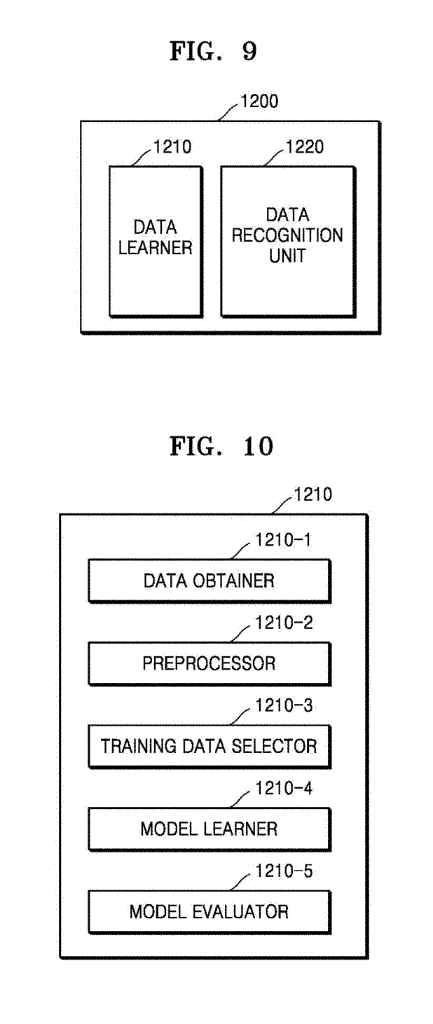

FIG. 9 is a block diagram of a controller of FIGS. 1 and 8 according to an embodiment of the present disclosure.

Referring to FIG. 9, according to some embodiments, the controller 1200 may include a data learner 1210 and a data recognition unit 1220.

The data learner 1210 may learn a criterion for checking whether content corresponds to an abnormal pattern. The data learner 1210 may learn training data to be used to check whether the content corresponds to an abnormal pattern, and a criterion for checking whether the content corresponds to an abnormal pattern on the basis of the training data. The data learner 1210 may learn the criterion for checking whether the content corresponds to an abnormal pattern by obtaining training data to be used for the above-described learning and applying the obtained data to a data recognition model which will be described below.

The data learner 1210 may create the data recognition model for estimating whether content corresponds to an abnormal pattern by making the data recognition model to be learned using the content. In this case, the content may include at least one among text, an image, and a moving picture.

The data learner 1210 may allow the data recognition model to be learned by using, as training data, content, data regarding the other party who will share the content, and a permissible level.

In an embodiment, the data recognition model may be a model which is set to estimate whether text corresponds to an abnormal pattern. In this case, training data may include the text, data regarding the other party who will share the text, and a permissible level.

For example, the training data may include text “hi”, data regarding the other party “father” who will share the text, and a permissible level which is a “transmission prevention level”. Alternatively, the training data may include the text “hi”, a group of other parties “friends” who will share the text, and a permissible level which is a “transmission permission level”.

In various embodiments, the data recognition model may be a model which is set to estimate whether an image corresponds to an abnormal pattern. In this case, training data may include the image, information regarding the other party who will share the image, and a permissible level.

For example, the training data may include an “image in which a man and a woman are embracing each other”, the other party “mother” who will share the image, and a permissible level which is a “transmission prevention level”. Alternatively, the training data include the “image in which the man and the woman are embracing each other”, the other party “friend” who will share the image, and a permissible level which is a “transmission permission level”.

As described above, the data learner 1210 may allow the data recognition model to be learned using various types of data corresponding to a permissible level which varies according to a target to which content will be transmitted with respect to even the same content.

The model which is set to estimate whether text corresponds to an abnormal pattern and the model which is set to estimate whether an image corresponds to an abnormal pattern may be the same recognition model or different recognition models. The same recognition model or the different data recognition models may each include either a plurality of data recognition models or one data recognition model.

The data recognition unit 1220 may check whether content corresponds to an abnormal pattern on the basis of various types of recognition data. The data recognition unit 1220 may check whether content corresponds to an abnormal pattern by using a learned data recognition model and on the basis of content which is input by a user and data regarding the other party who will share the input data.

The data recognition unit 1220 may check whether the content corresponds to an abnormal pattern by obtaining the content which is input by the user and the data regarding the other party who will share the input content according to a criterion predetermined through learning and using the data recognition model with the obtained data as an input value. The data recognition unit 1220 may use a result of checking whether the content corresponds to an abnormal pattern by using, as input values of the data recognition model, the content which is input by the user and the data regarding the other party who will share the input content and the user's response to the result of the determination so as to refine the data recognition model.

In an embodiment, the data recognition model may be a model which is set to estimate whether text corresponds to an abnormal pattern. In this case, the data recognition unit 1220 may estimate whether the text corresponds to an abnormal pattern by applying the text as data to be recognized to the data recognition model.

For example, when text “what's up?” is input to a text messenger application and a target to which the text is to be transmitted is “mother”, the data recognition unit 1220 may estimate the text to correspond to a “transmission prevention level”. When the text “what's up?” is input to the text messenger application and a target to which the text is to be transmitted belongs to a “friend” group, the data recognition unit 1220 may estimate the text to correspond to a “transmission permission level”.

In various embodiments, the data recognition model may be a model which is set to estimate whether an image corresponds to an abnormal pattern. In this case, the data recognition unit 1220 may estimate whether the image corresponds to an abnormal pattern by applying the image as data to be recognized to the data recognition model.

For example, when in a text message application, an “image of a man and a woman who are wearing swimming suits” are attached and a target to which the image is to be transmitted belongs to a “family” group, the data recognition unit 1220 may estimate the image to correspond to a “transmission prevention level”. When in the text message application, the “image of the man and the woman who are wearing swimming suits” are attached and a target to which the image is to be transmitted belongs to a “friend” group, the data recognition unit 1220 may estimate the image to correspond to a “transmission permission level”.

At least one of the data learner 1210 and the data recognition unit 1220 may be manufactured in the form of at least one hardware chip and installed in an electronic device. For example, at least one of the data learner 1210 and the data recognition unit 1220 may be manufactured in the form of a hardware chip dedicated to artificial intelligence (AI) or as a part of an existing general-purpose processor (e.g., a central processing unit (CPU) or an application processor (AP) or a graphic-exclusive processor (e.g., a graphics processing unit (GPU)), and be then installed in various types of electronic device as described above.

In an embodiment, the hardware chip dedicated for AI is a dedicated processor specialized for probability calculation, has higher parallel processing capability than those of existing general-purpose processors, and is thus capable of processing arithmetic operations in the field of AI, e.g., machine learning, at high speeds.

The data learner 1210 and the data recognition unit 1220 may be installed in one electronic device or different electronic devices. For example, the data learner 1210 or the data recognition unit 1220 may be included in an electronic device and the other may be included in a server. The data learner 1210 and the data recognition unit 1220 may be connected to each other via wire or wirelessly such that information regarding models constructed by the data learner 1210 may be provided to the data recognition unit 1220 and data input to the data recognition unit 1220 may be provided as additional training data to the data learner 1210.

At least one of the data learner 1210 and the data recognition unit 1220 may be embodied as a software (S/W) module. When at least one of the data learner 1210 and the data recognition unit 1220 is embodied as the S/W module (or a program module including instructions), the S/W module may be stored in non-transitory computer-readable media. In this case, at least one S/W module may be provided by an operating system (OS) or a certain application. Alternatively, some of the at least one S/W module may be provided by the OS and the other S/W module may be provided by the application.

FIG. 10 is a block diagram of a data learner of FIG. 9 according to an embodiment of the present disclosure.

Referring to FIG. 10, according to some embodiments, the data learner 1210 may include a data obtainer 1210-1, a preprocessor 1210-2, a training data selector 1210-3, a model learner 1210-4, and a model evaluator 1210-5. In an embodiment, the data learner 1210 may essentially include the data obtainer 1210-1 and the model learner 1210-4, and may further selectively include at least one among the preprocessor 1210-2, the training data selector 1210-3, and the model evaluator 1210-5 or may not include any of the preprocessor 1210-2, the training data selector 1210-3, and the model evaluator 1210-5.

The data obtainer 1210-1 may obtain training data needed to learn a criterion for checking whether content corresponds to an abnormal pattern. The data obtainer 1210-1 may obtain training data needed to check whether content corresponds to an abnormal pattern.

For example, the data obtainer 1210-1 may obtain video data (e.g., an image or a moving picture), text data, voice data, or the like as training data. For example, the data obtainer 1210-1 may obtain data directly input or selected via the user input unit 1310 of the content processing apparatus 1000. Alternatively, the data obtainer 1210-1 may obtain data received via an external device communicating with the content processing apparatus 1000.

The data obtainer 1210-1 may obtain, as training data, data input by a user, data stored previously in the content processing apparatus 1000, data received from a server and the like, but is not limited thereto. The data obtainer 1210-1 may obtain necessary training data from a combination of the data input by the user, the data stored previously in the content processing apparatus 1000, and the data received from the server.

Training data which may be obtained by the data obtainer 1210-1 may include at least one data form among text, an image, a moving picture, and voice. For example, an image may be input to the data obtainer 1210-1.

The preprocessor 1210-2 may preprocess obtained training data such that the training data may be used to learn to check whether content corresponds to an abnormal pattern. The preprocessor 1210-2 may process the obtained training data into a predetermined format such that the model learner 1210-4 which will be described below may learn to identify a situation.

For example, the preprocessor 1210-2 may remove noise from the training data, such as text, an image, a moving picture, voice, etc., obtained by the data obtainer 1210-1 or process the training data into a predetermined format to select meaningful data.

The training data selector 1210-3 may select training data needed for learn to check whether content corresponds to an abnormal pattern from the preprocessed training data. The selected training data may be provided to the model learner 1210-4. The training data selector 1210-3 may select training data needed to learn to check whether content corresponds to an abnormal pattern from the preprocessed training data according to a predetermined criterion for checking whether content corresponds to an abnormal pattern. Furthermore, the training data selector 1210-3 may select training data according to a criterion predetermined through learning performed by the model learner 1210-4 which will be described below.

The training data selector 1210-3 may have a data selection criterion for each of data types such as text, an image, a moving picture, and voice, and may select training data needed to learn using such a criterion. For example, the training data selector 1210-3 may obtain a relation type representing a relation between a person who will transmit content, such as text, an image, a moving picture, or voice, and a person who will receive the content, or key features which are important parameters for checking whether transmission of the content corresponds to an abnormal pattern from text, an image, a moving picture, or voice included in the content.

The model learner 1210-4 may learn a criterion for checking whether content corresponds to an abnormal pattern on the basis of the training data. Furthermore, the model learner 1210-4 may learn a criterion for a type of training data to be used to check whether content corresponds to an abnormal pattern.

The model learner 1210-4 may learn a criterion for checking whether input content corresponds to an abnormal pattern. The model learner 1210-4 may learn criteria corresponding to other parties to learn a criterion corresponding to the other party who will share content which is input by a user. The model learner 1210-4 may learn sub-criteria corresponding to types of abnormal patterns. The model learner 1210-4 may learn a criterion for checking whether input content corresponds to an abnormal pattern on the basis of a public model at an initial learning stage, and may learn a criterion for checking whether input content corresponds to an abnormal pattern on the basis of a private model corresponding to a certain other party as learning is cumulatively performed.

Furthermore, the model learner 1210-4 may allow a data recognition model, which is to be used to determine whether content corresponds to an abnormal pattern, to be learned using training data. In this case, the data recognition model may be a previously constructed model. For example, the data recognition model may be a model previously constructed by receiving basic training data (e.g., sample text, etc.).

The data recognition model may be constructed in consideration of a field of application of recognition models, a purpose of learning, or the computer performance of a device, etc. The data recognition model may be, for example, a neural network-based model. The data recognition model may be designed to simulate a human brain structure in a computer. The data recognition model may include a plurality of network nodes which are configured to simulate neurons of a human neural network and to which a weight is assigned. The plurality of network nodes may be connected to simulate synaptic activities of neurons exchanging signals via a synapse. The data recognition model may include, for example, a neural network model or a deep learning model developed from the neural network model. In the deep learning model, the plurality of network nodes may be located at different depths (or different layers) and may exchange data with each other according to a convolution connection. For example, a model such as a deep neural network (DNN), a recurrent neural network (RNN), or a bidirectional recurrent DNN (BRDNN) may be used as the data recognition model but embodiments are not limited thereto.

In various embodiments, when there are a plurality of previously constructed data recognition models, the model learner 1210-4 may determine a data recognition model having an intimate correlation between received training data and basic training data to be the data recognition model to be learned. In this case, the basic training data may be previously classified according to data types, and the data recognition model may be previously constructed according to data types. For example, the basic training data may be previously classified according to various criteria, e.g., a place in which training data was created, time when the training data was created, a size of the training data, a genre of the training data, a creator of the training data, and the types of objects included in the training data.

The model learner 1210-4 may allow the data recognition model to be learned using, for example, a learning algorithm including error back-propagation or gradient descent.

The model learner 1210-4 may allow the data recognition model to be learned through, for example, supervised learning performed using training data as an input value. The model learner 1210-4 may also allow the data recognition model to be learned through, for example, unsupervised learning performed to detect a criterion for checking whether content corresponds to an abnormal pattern by self-learning a type of training data needed to check whether content corresponds to an abnormal pattern without any supervision. In addition, the model learner 1210-4 may allow the data recognition model to be learned through, for example, reinforcement learning performed using a feedback indicating whether a result of checking whether content corresponds to an abnormal pattern through learning is correct.

When the data recognition model is learned, the model learner 1210-4 may store the learned data recognition model. In this case, the model learner 1210-4 may store the learned data recognition model in a memory of an electronic device including the data recognition unit 1220. Alternatively, the model learner 1210-4 may store the learned data recognition model in a memory of an electronic device including the data recognition unit 1220, which will be described below. Alternatively, the model learner 1210-4 may store the learned data recognition model in a memory of a server connected to an electronic device via wire or wirelessly.

In this case, the memory in which the learned data recognition model is stored may also store, for example, an instruction or data related to at least another component of an electronic device. Furthermore, the memory may store S/W and/or a program. The program may include, for example, kernel, middleware, an API and/or an application program (or an “application”).

The model evaluator 1210-5 may input evaluation data to the data recognition model, and allow the model learner 1210-4 to perform learning when a recognition result output from the evaluation data does not satisfy a certain criterion. In this case, the evaluation data may be predetermined data for evaluating the data recognition model.

For example, when the number or rate of pieces of evaluation data corresponding to incorrect recognition results among recognition results of the data recognition model learned with respect to evaluation data is greater than a predetermined threshold value, the model evaluator 1210-5 may evaluate that the criterion is not satisfied. For example, if the certain criterion is defined as a ratio of 2%, when the learned data recognition model outputs incorrect recognition results with respect to more than 20 pieces of evaluation data among a total of 1000 pieces of evaluation data, the model evaluator 1210-5 may evaluate that the learned data recognition model is inappropriate.

When there are a plurality of learned data recognition models, the model evaluator 1210-5 may evaluate whether each of the plurality of learned data recognition models satisfies the criterion, and identify a data recognition model satisfying the criterion as a final data recognition model. In this case, when there are a plurality of models satisfying the criterion, the model evaluator 1210-5 may identify, as a final data recognition model(s), a model or a predetermined number of models which have been set in the order of higher scores.

At least one among the data obtainer 1210-1, the preprocessor 1210-2, the training data selector 1210-3, the model learner 1210-4, and the model evaluator 1210-5 included in the data learner 1210 may be manufactured in the form of at least one hardware chip and installed in an electronic device. For example, at least one among the data obtainer 1210-1, the preprocessor 1210-2, the training data selector 1210-3, the model learner 1210-4, and the model evaluator 1210-5 may be manufactured in the form of hardware chip dedicated to AI or as a part of an existing general-purpose processor (e.g., a CPU or an AP) or a graphic-exclusive processor (e.g., a GPU), and be then installed in various types of electronic devices as described above.

The data obtainer 1210-1, the preprocessor 1210-2, the training data selector 1210-3, the model learner 1210-4, and the model evaluator 1210-5 may be installed in one electronic device or different electronic devices. For example, some of the data obtainer 1210-1, the preprocessor 1210-2, the training data selector 1210-3, the model learner 1210-4, and the model evaluator 1210-5 may be included in an electronic device and the other components may be included in a server.

At least one among the data obtainer 1210-1, the preprocessor 1210-2, the training data selector 1210-3, the model learner 1210-4, and the model evaluator 1210-5 may be embodied as a S/W module. When at least one among the data obtainer 1210-1, the preprocessor 1210-2, the training data selector 1210-3, the model learner 1210-4, and the model evaluator 1210-5 is embodied as a S/W module (or a program module including an instruction), the S/W module may be stored in non-transitory computer readable media. In this case, at least one S/W module may be provided from an OS or a certain application. Alternatively, some of the at least one S/W module may be provided from the OS and the other S/W module may be provided from the application.

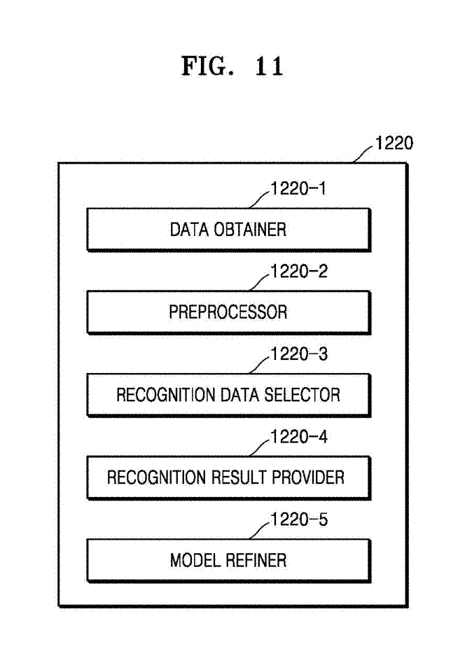

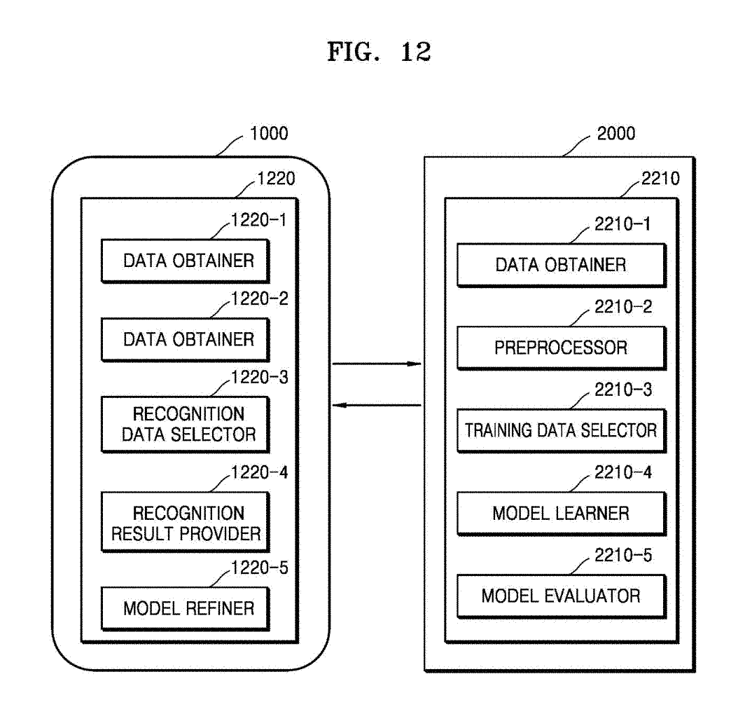

FIG. 11 is a block diagram of a data recognition unit of FIG. 9 according to an embodiment of the present disclosure.

Referring to FIG. 11, according to some embodiments, the data recognition unit 1220 may include a data obtainer 1220-1, a preprocessor 1220-2, a recognition data selector 1220-3, a recognition result provider 1220-4, and a model refiner 1220-5. In an embodiment, the data recognition unit 1220 may essentially include the data obtainer 1220-1 and the recognition result provider 1220-4, and may further selectively include at least one among the preprocessor 1220-2, the recognition data selector 1220-3, and the model refiner 1220-5 or may not include the preprocessor 1220-2, the recognition data selector 1220-3, and the model refiner 1220-5.

The data recognition unit 1220 may check whether content input by a user corresponds to an abnormal pattern by using a learned data recognition model on the basis of a permissible level corresponding to the other party who will share the content.

The data obtainer 1220-1 may obtain recognition data needed to check whether the content corresponds to an abnormal pattern. For example, the data obtainer 1210-1 may obtain video data, text data, voice data, or the like as the recognition data. For example, the data obtainer 1210-1 may obtain data directly input or selected via the user input unit 1310 of the content processing apparatus 1000. Alternatively, the data obtainer 1210-1 may obtain data received via an external device communicating with the content processing apparatus 1000.

The preprocessor 1220-2 may preprocess the obtained recognition data such that the obtained recognition data may be used to check whether the content corresponds to an abnormal pattern. The preprocessor 1220-2 may process the obtained recognition data into a predetermined format such that the recognition result provider 1220-4 which will be described below may use the obtained recognition data to check whether the content corresponds to an abnormal pattern.

For example, the preprocessor 1220-2 may remove noise from the recognition data, such as text, an image, a moving picture, or voice, obtained by the data obtainer 1220-1 or process the recognition data into a predetermined format to select meaningful data from the recognition data.

The recognition data selector 1220-3 may select recognition data to be used to check whether the content corresponds to an abnormal pattern from the preprocessed recognition data. The selected recognition data may be provided to the recognition result provider 1220-4. The recognition data selector 1220-3 may select a part of or all the preprocessed recognition data according to a predetermined criterion for checking whether the content corresponds to an abnormal pattern. Alternatively, the recognition data selector 1220-3 may select the recognition data through learning performed by the model learner 1210-4 which will be described below according to the predetermined criterion.

The recognition result provider 1220-4 may identify a situation by applying the selected recognition data to the data recognition model. The recognition result provider 1220-4 may provide a result of recognition according to a purpose of recognizing the recognition data. The recognition result provider 1220-4 may apply the selected recognition data to the data recognition model by using the recognition data selected by the recognition data selector 1220-3 as an input value. The result of recognition may be determined using the data recognition model.

For example, the recognition data selector 1220-3 may select a subject which will input the content, information regarding the other party, and recognition data corresponding to a relation between the subject and the other party. Alternatively, the recognition data selector 1220-3 may select some recognition data from the content input by the user. At least one piece of recognition data selected by the recognition data selector 1220-3 may be used as situation information when whether the content corresponds to an abnormal pattern is determined.

The recognition result provider 1220-4 may check whether the content corresponds to an abnormal pattern on the basis of the criterion for checking whether the input content corresponds to an abnormal pattern. The recognition result provider 1220-4 may check whether the content corresponds to an abnormal pattern on the basis of a criterion corresponding to the other party who will share the content input by the user. The recognition result provider 1220-4 may use sub-criteria corresponding to types of abnormal patterns. The recognition result provider 1220-4 may check whether content corresponds to an abnormal pattern on the basis of a public model at an initial learning stage. Then, as learning is accumulated, the recognition result provider 1220-4 may check whether input content corresponds to an abnormal pattern on the basis of a private model corresponding to a certain other party at a cumulative learning stage.

The model refiner 1220-5 may refine the data recognition model on the basis of an evaluation of a recognition result of the recognition result provider 1220-4. For example, the model refiner 1220-5 may provide the model learner 1210-4 with a result of checking whether the content corresponds to an abnormal pattern, which is provided by the recognition result provider 1220-4, so that the model learner 1210-4 may refine the data recognition model.

When the content corresponds to an abnormal pattern, the model refiner 1220-5 may adjust the criterion for checking whether the content corresponds to an abnormal pattern on the basis of the user's response to notification regarding detection of the abnormal pattern. For example, when the user transmits the content from which the abnormal pattern is detected to the other party, the model refiner 1220-5 may adjust the criterion such that similar content which is input thereafter and which corresponds to the abnormal pattern is treated as a normal pattern. The model refiner 1220-5 may adjust sub-criteria corresponding to the types of abnormal patterns on the basis of the user's response. When input content does not correspond to an abnormal pattern, the model refiner 1220-5 may adjust the criterion for checking whether the input content corresponds to an abnormal pattern on the basis of the other party's response or the user's response after transmission of the content.

At least one among the data obtainer 1220-1, the preprocessor 1220-2, the recognition data selector 1220-3, the recognition result provider 1220-4, and the model refiner 1220-5 included in the data recognition unit 1220 may be manufactured in the form of at least one hardware chip and installed in an electronic device. For example, at least one among the data obtainer 1220-1, the preprocessor 1220-2, the recognition data selector 1220-3, the recognition result provider 1220-4, and the model refiner 1220-5 may be manufactured in the form of a hardware chip dedicated to AI or as a part of an existing general-purpose processor (e.g., a CPU or an AP) or a graphic-exclusive processor (e.g., a GPU), and be then installed in various types of electronic devices.

Alternatively, the data obtainer 1220-1, the preprocessor 1220-2, the recognition data selector 1220-3, the recognition result provider 1220-4, and the model refiner 1220-5 may be installed in one electronic device or different electronic devices. For example, some of the data obtainer 1220-1, the preprocessor 1220-2, the recognition data selector 1220-3, the recognition result provider 1220-4, and the model refiner 1220-5 may be included in an electronic device and the other components may be included in a server.

Alternatively, at least one among the data obtainer 1220-1, the preprocessor 1220-2, the recognition data selector 1220-3, the recognition result provider 1220-4, and the model refiner 1220-5 may be embodied as a S/W module. When at least one among the data obtainer 1220-1, the preprocessor 1220-2, the recognition data selector 1220-3, the recognition result provider 1220-4, and the model refiner 1220-5 is embodied as a S/W module (or a program module including an instruction), the S/W module may be stored in non-transitory computer readable media. In this case, at least one S/W module may be provided by an OS or a certain application. Alternatively, some of the at least one S/W module may be provided by an OS and the other S/W module may be provided by the application.

FIG. 12 is a diagram illustrating an example in which data is learned and recognized by linking a content processing apparatus and a server to each other, according to an embodiment of the present disclosure.

Referring to FIG. 12, a server 2000 may learn a criterion for checking whether content corresponds to an abnormal pattern. The content processing apparatus 1000 may check whether content input by a user corresponds to an abnormal pattern by using a data recognition model learned by the server 2000.

In this case, a data learner 2210 of the server 2000 may perform a function of the data learner 1210 illustrated in FIG. 10. The data learner 2210 may include a data obtainer 2210-1, a preprocessor 2210-2, a training data selector 2210-3, a model learner 2210-4, and a model evaluator 2210-5. The data learner 2210 of the server 2000 may learn a type of training data to be used or learn a criterion for checking whether the content corresponds to an abnormal pattern by using the training data to check whether the content corresponds to an abnormal pattern. The data learner 2210 of the server 2000 may learn the criterion for checking whether the content corresponds to an abnormal pattern by obtaining training data to be used for learning and applying the obtained training data to a data recognition model which will be described below.

A recognition result provider 1220-4 of the content processing apparatus 1000 may check whether the content corresponds to an abnormal pattern by applying recognition data selected by a recognition data selector 1220-3 to a data recognition model created by the server 2000. For example, the recognition result provider 1220-4 may transmit the recognition data selected by the recognition data selector 1220-3 to the server 2000 to request the server 2000 to check whether the content corresponds to an abnormal pattern by applying the recognition data selected by the recognition data selector 1220-3 to the data recognition model. Furthermore, the recognition result provider 1220-4 may receive a result of checking whether the content corresponds to an abnormal pattern, the checking being performed by the server 2000, from the server 2000.

For example, the content processing apparatus 1000 may transmit the content input by the user and data regarding the other party which is obtained by the content processing apparatus 1000 to the server 2000. The server 2000 may check whether the content corresponds to an abnormal pattern by applying the content and the data regarding the other party which are received from the content processing apparatus 1000 to the data recognition model stored in the server 2000. The server 2000 may check whether the content corresponds to an abnormal pattern by additionally reflecting data regarding the other party which is obtained by the server 2000. The result of checking whether the content corresponds to an abnormal pattern, the checking being performed by the server 2000, may be transmitted to the content processing apparatus 1000.

Alternatively, a recognition result provider 1220-4 of the content processing apparatus 1000 may receive the data recognition model created by the server 2000 from the server 2000, and check whether the content corresponds to an abnormal pattern by using the received data recognition model. In this case, the recognition result provider 1220-4 of the content processing apparatus 1000 may check whether the content corresponds to an abnormal pattern by applying the recognition data selected by the recognition data selector 1220-3 to the data recognition model received from the server 2000.

For example, the content processing apparatus 1000 may check whether the content corresponds to an abnormal pattern by applying the content input by the user and the data regarding the other party which is obtained by the content processing apparatus 1000 to the data recognition model received from the server 2000. The server 2000 may transmit the data regarding the other party which is obtained by the server 2000 to the content processing apparatus 1000 so that the content processing apparatus 1000 may additionally use this data during the checking as to whether the content corresponds to an abnormal pattern.

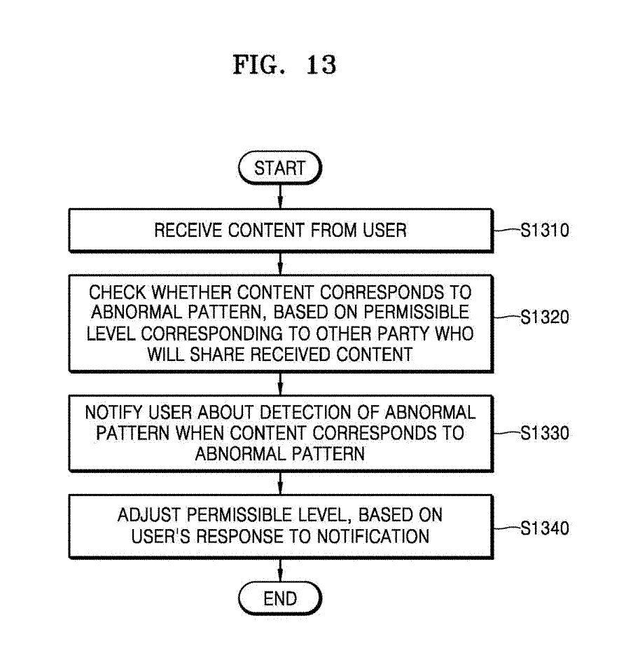

FIG. 13 is a flowchart of a method of processing content, according to an embodiment of the present disclosure.

In operation S1310, the content processing apparatus 1000 of FIG. 1 receives content from a user.

In operation S1320, the content processing apparatus 1000 checks whether the content corresponds to an abnormal pattern on the basis of a permissible level corresponding to the other party who will share the content received from the user.

The content processing apparatus 1000 may obtain at least one feature to be used to identify the user's pattern by analyzing the content received from the user, and detect an abnormal pattern on the basis of the obtained feature and the permissible level.

When there is no information regarding the permissible level corresponding to the other party, the content processing apparatus 1000 may check whether the content corresponds to an abnormal pattern on the basis of a permissible level corresponding to a relation type to which the other party belongs.

In operation S1330, when the content corresponds to an abnormal pattern, the content processing apparatus 1000 notify the user about detection of the abnormal pattern.

When the content corresponds to an abnormal pattern, the content processing apparatus 1000 may stop transmission of the content regardless of the user's command to transmit the content. The content processing apparatus 1000 may provide the notification regarding the detection of the abnormal pattern, together with a manipulation interface permitting cancellation of the transmission of the content.

In operation S1340, the content processing apparatus 1000 adjusts the permissible level on the basis of the user's response to the notification regarding the detection of the abnormal pattern.

When the user transmits content from which an abnormal pattern is detected to the other party who will share the content, the content processing apparatus 1000 may adjust the permissible level such that similar content corresponding to the detected abnormal pattern may be treated as a normal pattern.

The content processing apparatus 1000 may gradually adjust the permissible level by cumulatively learning a normal pattern of content in relation to the other party according to the user's response.

When the permissible level includes sub-permissible levels corresponding to types of abnormal patterns, the content processing apparatus 1000 may adjust a sub-permissible level corresponding to the abnormal pattern detected from the content on the basis of the user's response.

The content processing apparatus 1000 may independently adjust only a permissible level corresponding to the other party according to the user's response.

When the content does not correspond to an abnormal pattern, the content processing apparatus 1000 may adjust the permissible level on the basis of the other party's response or the user's response after transmission of the content.

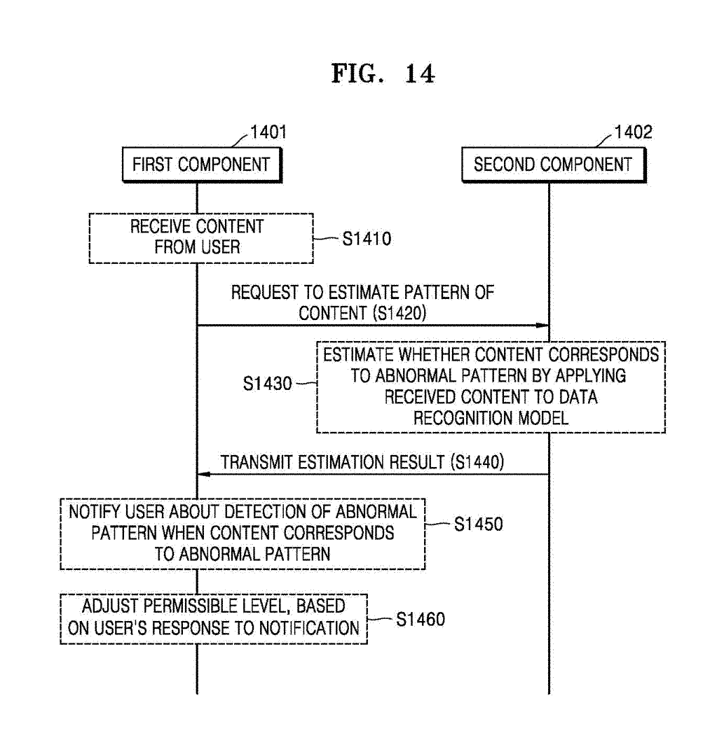

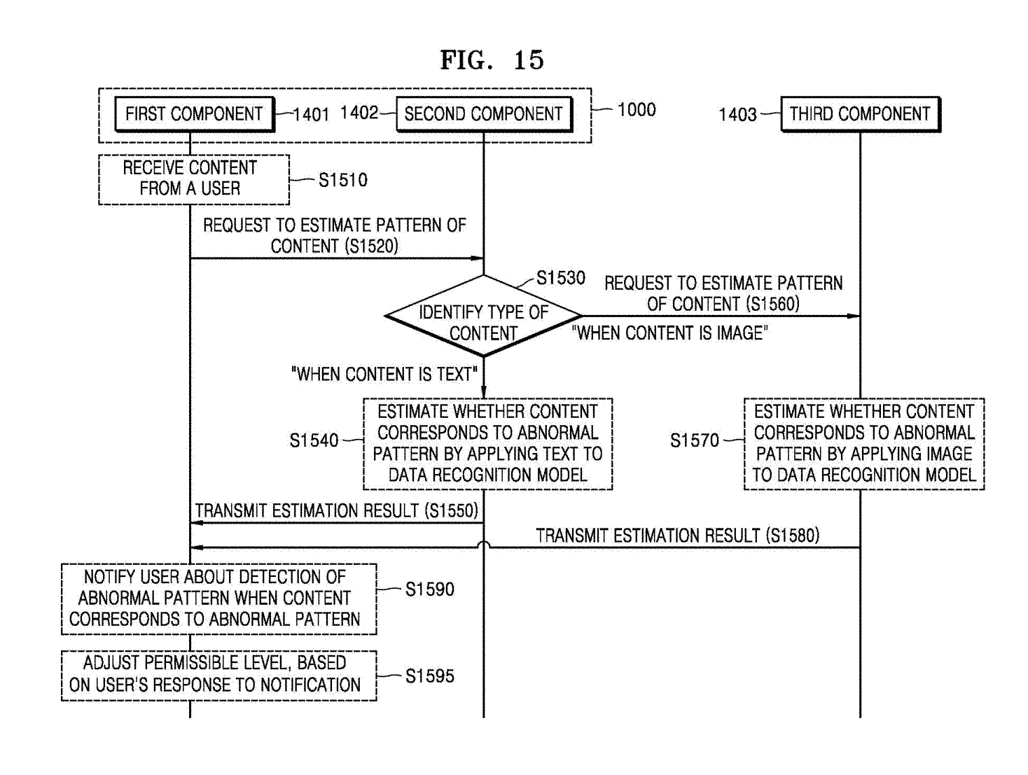

FIGS. 14 and 15 are flowcharts for explaining situations in which a data recognition model is used according to various embodiments of the present disclosure.

Referring to FIGS. 14 and 15, a first component 1401 may be the content processing apparatus 1000 of FIG. 1 and a second component 1402 may be a server storing a data recognition model (e.g., the server 2000 of FIG. 12). Alternatively, the first component 1401 may be a general-purpose processor and the second component 1402 may be a processor dedicated to AI. Alternatively, the first component 1401 may be at least one application and the second component 1402 may be an OS.

That is, the second component 1402 may be a component which is more integrated, is more exclusive, may achieve a smaller delay, has higher performance, or has more resources, and is capable of more quickly and effectively processing a large number of operations required to generate, refine, or apply a data recognition model than the first component 1401. In various embodiments, a third component 1403 configured to perform functions similar to those of the second component 1402 may be added.

In this case, an interface for transmitting/receiving data between the first component 1401 and the second component 1402 may be defined.

For example, an API including, as a factor value (or a parameter or a value to be transferred), training data to be applied to the data recognition model may be defined. The API may be defined as a set of sub-routines or functions which may be called to execute a protocol (e.g., a protocol defined by the server 2000) according to a protocol (e.g., a protocol defined by the content processing apparatus 1000). That is, an environment in which a protocol can be executed according to another protocol may be provided through the API.

FIG. 14 is a flowchart for explaining a situation in which an estimate of whether content corresponds to an abnormal pattern is made using a data recognition model, the estimation being performed by the second component.

In operation S1410, the first component 1401 may receive content from a user.

In operation S1420, the first component 1401 may request the second component 1402 to estimate a pattern of the received content.

In operation S1430, the second component 1402 may estimate whether the content corresponds to an abnormal pattern by applying the content received from the user to a data recognition model.

A data recognition unit included in the second component 1402 may estimate whether the content corresponds to an abnormal pattern by obtaining at least one feature to be used to identify a pattern of the content by analyzing the content and then estimating a permissible level on the basis of the obtained feature and information regarding the other party who will share the content.

In operation S1440, the second component 1402 may transmit a result of estimating whether the content corresponds to an abnormal pattern to the first component 1401.

In operation S1450, when the content corresponds to an abnormal pattern, the first component 1401 may notify the user about detection of the abnormal pattern. For example, even if a command to transmit the content is received from the user, the first component 1401 may display an interface notifying the detection of the abnormal pattern and generate a manipulation interface permitting cancellation of transmission of the content.

In operation S1460, the first component 1401 may adjust a permissible level on the basis of the user's response to the notification regarding the detection of the abnormal pattern. For example, when the user transmits content to the first component 1401, the first component 1401 may adjust levels of the content and content similar to the content to be transmission permission level according to a relation between the user and the other party.

In various embodiments, the first component 1401 may adjust the permissible level on the basis of the other party's response or the user's response after transmission of the content.

FIG. 15 is a flowchart for explaining a situation in which an estimate of whether content corresponds to an abnormal pattern is made using a data recognition model and on the basis of a type of the content, the estimation being performed by the second component and a third component according to an embodiment.

In an embodiment, the first component 1401 and the second component 1402 may be components included in a content processing apparatus 1000, and a third component 1403 may be a component located outside the content processing apparatus 1000, but embodiments are not limited thereto.

In operation S1510, the first component 1401 may receive content from a user.

In operation S1520, the first component 1401 may request the second component 1402 to estimate a pattern of the received content.

In operation S1530, the second component 1402 may identify a type of the received content.

In operation S1540, when the content is text, the second component 1402 may estimate whether the text corresponds to an abnormal pattern by applying the text to a data recognition model which is set to estimate whether text corresponds to an abnormal pattern.

For example, a data recognition unit included in the second component 1402 may estimate whether the text corresponds to an abnormal pattern by checking whether the text contains a swear word or a discriminative word, such as a racist word or a sexist word, or contains a polite expression, and estimating a permissible level on the basis of information regarding the other party who will share the text.

In operation S1550, the second component 1402 may transmit a result of estimating whether the text corresponds to an abnormal pattern to the first component 1401.

In operation S1560, when the content is an image or otherwise not text, the second component 1402 may request the third component 1403 to estimate a pattern of the image.

In operation S1570, when the content is the image, the third component 1403 may estimate whether the image corresponds to an abnormal pattern by applying the image to a data recognition model which is set to estimate whether an input image corresponds to an abnormal pattern.

For example, a data recognition unit included in the third component 1403 may estimate whether the image corresponds to an abnormal pattern by checking whether a character is detected from the image, checking whether there is much light orange color in the character when the character is detected, and estimating a permissible level on the basis of information regarding the other party who will share the image.

In operation S1580, the third component 1403 may transmit a result of estimating whether the image corresponds to an abnormal pattern to the first component 1401.

In operation S1590, when the content corresponds to an abnormal pattern, the first component 1401 may notify the user about detection of the abnormal pattern.

In operation S1595, the first component 1401 may adjust the permissible level on the basis of the user's response to the notification regarding the detection of the abnormal pattern.

The methods of processing content as described above may be embodied as a program executable by a computer, and implemented in a general-purpose computer capable of executing the program using a non-transitory computer-readable storage medium. Examples of the non-transitory computer-readable recording medium may include ROMs, RAMs, flash memories, compact disc ROMs (CD-ROMs), CD-Rs, CD+Rs, CD-RWs, CD+RWs, digital versatile disc (DVD)-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard discs, solid-state disks (SSDs), and any other types of devices capable of storing instructions or software, data related thereto, data files, and data structures and providing the instructions or S/W, the data related thereto, the data files, and the data structures such that a processor or a computer can execute the instructions.

Alternatively, the methods according to the embodiments set forth herein may be provided in the form of a computer program product.

The computer program product may include a S/W program, a non-transitory computer-readable recording medium storing the S/W program, or a product traded between a seller and a buyer.

For example, the computer program product may include the content processing apparatus 1000 or a S/W program type product (e.g., a downloadable application) which is electronically distributed by the manufacturer of the content processing apparatus 1000 or at an electronic market (e.g., the Google play store, or an application store). For the electric distribution, at least a part of the S/W program may be stored in a storage medium or temporarily generated. In this case, the storage medium may be a storage medium of a server of the manufacturer or the electronic market or a storage medium of an intermediate server.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for processing content, the apparatus comprising:
a memory configured to store computer executable instructions;
at least one processor configured to execute the computer executable instructions that cause the at least one processor to:
determine whether content input by a user corresponds to an abnormal pattern based on a permissible level corresponding to another party who is to share the content, and
adjust the permissible level based on the user's response to a notification regarding detection of the abnormal pattern when the content corresponds to the abnormal pattern; and
an input and output unit configured to:
receive the content from the user,
notify the user about the detection of the abnormal pattern, and
receive the user's response to the notification.

2. The apparatus of claim 1, wherein the at least one processor is further configured to, when the user transmits the content from which the abnormal pattern is detected to the other party who is to share the content, adjust the permissible level such that content similar to the content and corresponding to the abnormal pattern is treated as a normal pattern.

3. The apparatus of claim 1, wherein the at least one processor is further configured to gradually adjust the permissible level by cumulatively learning normal patterns of content in relation to the other party according to the user's response.

4. The apparatus of claim 1,
wherein the permissible level comprises sub-permissible levels corresponding to types of abnormal patterns, and
wherein the at least one processor is further configured to adjust a sub-permissible level corresponding to a type of the abnormal pattern detected from the content based on the user's response.

5. The apparatus of claim 1, wherein the at least one processor is further configured to independently adjust only the permissible level corresponding to the other party according to the user's response.

6. The apparatus of claim 1, wherein the at least one processor is further configured to, when the content does not correspond to the abnormal pattern, adjust the permissible level based on the other party's response or the user's response after transmission of the content.

7. The apparatus of claim 1, wherein the at least one processor is further configured to:
obtain at least one feature to be used to identify the user's pattern by analyzing the content, and
detect the abnormal pattern based on the obtained feature and the permissible level.

8. The apparatus of claim 1, wherein the at least one processor is further configured to, when there is no information regarding the permissible level corresponding to the other party, determine whether the content corresponds to the abnormal pattern based on a permissible level corresponding to a relation type to which the other party belongs.

9. The apparatus of claim 1,
wherein the at least one processor is further configured to, when the content corresponds to the abnormal pattern, stop transmission of the content, and
wherein the input and output unit is further configured to provide the notification regarding the detection of the abnormal pattern together with a manipulation interface permitting cancellation of the transmission of the content.

10. The apparatus of claim 1, wherein the permissible level is changed according to a change in information representing a level of intimacy between the other party and the user.

11. The apparatus of claim 1, wherein the at least one processor is further configured to determine whether the content corresponds to an abnormal pattern by using at least one of a rule-based algorithm or an artificial intelligence (AI) algorithm.

12. A method of processing content, the method comprising:
receiving content from a user;
determining whether the content corresponds to an abnormal pattern based on a permissible level corresponding to another party who is to share the content;
generating a notification to notify the user about detection of the abnormal pattern when the content corresponds to the abnormal pattern; and
adjusting the permissible level based on the user's response to the notification.

13. The method of claim 12, wherein the adjusting of the permissible level comprises adjusting the permissible level such that content similar to the content and corresponding to the abnormal pattern is treated as a normal pattern, when the user transmits the content from which the abnormal pattern is detected to the other party who is to share the content.

14. The method of claim 12, wherein the adjusting of the permissible level comprises gradually adjusting the permissible level by cumulatively learning normal patterns of content in relation to the other party according to the user's response.

15. The method of claim 12,
wherein the permissible level comprises sub-permissible levels corresponding to types of abnormal patterns, and
wherein the adjusting of the permissible level comprises adjusting a sub-permissible level corresponding to a type of the abnormal pattern detected from the content based on the user's response.

16. The method of claim 12, wherein the adjusting of the permissible level comprises independently adjusting only the permissible level corresponding to the other party according to the user's response.

17. The method of claim 12, further comprising, when the content does not correspond to the abnormal pattern, adjusting the permissible level based on the other party's response or the user's response after transmission of the content.

18. The method of claim 12, wherein the determining of whether the content corresponds to the abnormal pattern comprises:
obtaining at least one feature to be used to identify the user's pattern by analyzing the content; and
detecting the abnormal pattern based on the obtained at least one feature and the permissible level.

19. The method of claim 12, wherein the determining of whether the content corresponds to the abnormal pattern further comprises, when there is no information regarding the permissible level corresponding to the other party, determining whether the content corresponds to the abnormal pattern based on a permissible level corresponding to a relation type to which the other party belongs.

20. The method of claim 12, wherein the generating of the notification to notify the user about detection of the abnormal pattern comprises:
stopping transmission of the content when the content corresponds to the abnormal pattern; and
providing the notification regarding the detection of the abnormal pattern together with a manipulation interface permitting cancellation of the transmission of the content.

21. The method of claim 12, wherein the determining of whether the content corresponds to an abnormal pattern is performed using at least one of a rule-based algorithm or an artificial intelligence (AI) algorithm.

22. A non-transitory computer-readable recording medium having recorded thereon a program causing at least one processor of a computer to execute:
receiving content from a user;
determining whether the content corresponds to an abnormal pattern based on a permissible level corresponding to another party who is to share the content;
generating a notification to notify the user about detection of the abnormal pattern when the content corresponds to the abnormal pattern; and
adjusting the permissible level based on the user's response to the notification.

23. An apparatus for processing content, the apparatus comprising:
an input and output unit;
a memory; and
a processor;
wherein the memory stores instructions which, when executed, cause the processor to:
estimate whether at least one content item corresponds to an abnormal pattern by applying the at least one content item to a data recognition model,
control the input and output unit to output a notification notifying that the at least one content item corresponds to the abnormal pattern and receive the user's response to the notification when it is estimated that the at least one content item corresponds to the abnormal pattern, and
refine the data recognition model based on the user's response,
wherein the data recognition model is set to estimate whether content corresponds to an abnormal pattern based on a permissible level corresponding to another party who is to share the content, and
wherein the data recognition model is learned using, as training data, the at least one content item, information regarding the other party who is to share the at least one content item, and the permissible level.
